(19) United States
(12) Patent Application Publication
(10) Pub. No.: US 2011/0087515 A1
(43) Pub. Date: Apr. 14, 2011

(54) Cognitive interactive mission planning system and method

(76) Inventors: Bradford W. Miller, Narragansett, RI (US); Chung H. Hwang, Narragansett, RI (US)

(21) Appl. No.: 12/587,502

(22) Filed: Oct. 8, 2009

(51) Int. Cl. G06Q 10/00; G06N 5/02; G06Q 50/00

(52) U.S. Cl. 705/7.26; 706/52; 706/47; 705/7.13

(57) ABSTRACT

A cognitive interactive mission planning system including an adversarial planning engine configured to execute an adversarial planning model in order to develop one or more plans for one or more controlled agents based on possible actions of one or more uncontrolled agents to provide a plurality of plans which includes a best plan for the one or more controlled agents in each of the one or more possible worlds based on a scoring function. A cognitive behavior engine may be configured to execute a cognitive behavior model which predicts the likelihood the one or more controlled agents and/or the one or more uncontrolled agents will take one or more of the possible actions in a particular situation. A problem solver engine may be configured to query the adversarial planning engine and the cognitive behavior engine to develop a conditional mission plan which provides solutions to the user defined mission goals and problems.

### FIELD OF THE INVENTION

The subject invention relates generally to mission planning systems and more particularly to a cognitive interactive mission planning system which combines adversarial behavior planning with cognitive behavior planning.

### BACKGROUND OF THE INVENTION

Conventional mission planning systems may be used to provide a conditional mission plan to a user, e.g., a commander of a branch of the armed forces, such as the Army, Navy, Air Force, Marines, and the like. The conditional mission plan typically includes solutions to user defined goals and problems, as well as recommended actions for controlled agents based on predicted actions of enemy agents.

Some conventional adversarial planning systems rely on an artificial intelligence approach to adversarial planning wherein the system may utilize a model of a known set of objectives, a known state of a possible world (a “snapshot” of the state of a possible world), and a predetermined set of operations or actions. However, such systems may ignore the actual state of the known world and may not account for temporal (episodic) knowledge and thus generally lack the ability to accommodate exogenous events.

Other known adversarial planning system may not account for understanding the intention of the user, e.g., commander intent, and typically may not relate different causes of action to each other. Thus, the plans generated are often difficult to coherently explain to the commander.

Many conventional adversarial planning systems are often disconnected from automated operations and typically may not be modified without starting over. If the system does include plans for the actions of enemy agents, the plans often assume known intentions of the enemy agents and typically only accommodate the most dangerous actions the enemy agents will take.

Cognitive behavior models or systems typically employ cognitive psychology to predict how an agent or group of agents in one or more possible worlds will behave in a particular situation, e.g., what is the most likely action controlled agents (friendly agents) or uncontrolled agents (enemy agents) will perform.

However, to date, known conventional mission planning systems have yet to combine adversarial planning with cognitive behavior planning.

### BRIEF SUMMARY OF THE INVENTION

In one aspect, a cognitive interactive mission planning system apparatus is featured including a user interface engine configured to support mixed initiative interaction and user defined mission goals and problems. A knowledge base may be configured to store and retrieve domain knowledge and rules associated with properties of each of one or more possible worlds of interest and the user defined mission goals and problems. An adversarial planning engine may be configured to execute an adversarial planning model in order to develop one or more plans for one or more controlled agents based on possible actions of one or more uncontrolled agents to provide a plurality of plans which may include a best plan for the one or more controlled agents in each of the one or more possible worlds based on a scoring function. A cognitive behavior engine may be configured to execute a cognitive behavior model which predicts the likelihood the one or more controlled agents and/or the one or more uncontrolled agents will take one or more of the possible actions in a particular situation. A problem solver engine may be configured to query the adversarial planning engine and the cognitive behavior engine to develop a conditional mission plan which provides solutions to the user defined mission goals and problems.

In one embodiment, the user interface engine may include a display engine configured to display visualizations of the one or more possible worlds associated with one or more of the plurality of plans relevant to the current state of the mixed initiative interaction. The user interface engine may include a display management engine configured to control and maintain the state of the mixed initiative interaction. The scoring function may input each of the plurality of plans provided by the adversarial planning engine and generates a score which corresponds to how well each of the plurality of plans is achieved. The adversarial planning engine may be configured to suggest resolutions to possible conflicts of the best plan. The cognitive behavior engine may be configured to suggest resolutions to possible conflicts of the best plan. The cognitive behavior engine may be configured to predict the likelihood a modeled one or more uncontrolled agents will perform each of the one or more possible actions in each of the one or more possible worlds. The problem solver engine may integrate the adversarial planning model and the cognitive behavior model by comparing one or more predicted possible actions of one or more uncontrolled agents in each of the one or more possible worlds generated by the adversarial planning engine to predicted possible actions of the one or more uncontrolled agents in each of the one or more possible worlds generated by the cognitive behavior engine to determine if the actions of the uncontrolled agents predicted by the adversarial planning engine match the actions of the uncontrolled agents predicted by the cognitive behavior engine. The problem solver engine may initiate the adversarial planning engine to provide a new plurality of plans which includes a best plan for the one or more controlled agents when the actions of the uncontrolled agents predicted by the adversarial planning engine do not match the actions of the uncontrolled agents predicted by the cognitive behavior engine. The cognitive behavior engine may be configured to predict the most likely one or more possible actions the one or more uncontrolled agents will perform. The adversarial planning engine may be configured to predict the most dangerous one or more possible actions the one or more uncontrolled agents will perform. The system may further include a simulation engine configured to simulate a one or more the plurality of plans in and/or across one of the one or more possible worlds and configured to simulate one or more plans of the conditional mission plan and provide an assessment of the conditional mission plan based on a predetermined number of simulations of the conditional mission plan. The one or more possible worlds may include the modeled intention of the one or more controlled agents and/or the one or more uncontrolled agents.

In another aspect, a cognitive interactive mission planning system apparatus is featured including an adversarial planning engine configured to execute an adversarial planning model in order to develop one or more plans for one or more controlled agents based on possible actions of one or more uncontrolled agents to provide a plurality of plans which includes a best plan for the one or more controlled agents in each of the one or more possible worlds based on a scoring function. A cognitive behavior engine may be configured to execute a cognitive behavior model which predicts the likelihood the one or more controlled agents and/or the one or more uncontrolled agents will take one or more of the possible actions in a particular situation. A problem solver engine may be configured to query the adversarial planning engine and the cognitive behavior engine to develop a conditional mission plan which provides solutions to the user defined mission goals and problems.

In another aspect, a cognitive interactive mission planning method is featured including receiving input in the form of mixed initiative interaction and user defined mission goals and problems, storing and retrieving domain knowledge and rules associated with properties of each of one or more possible worlds of interest and the user defined mission goals and problems, executing an adversarial planning model in order to develop one or more plans for one or more controlled agents based on possible actions of one or more uncontrolled agents to provide a plurality of plans which includes a best plan for the one or more controlled agents in each of the one or more possible worlds based on a scoring function, executing a cognitive behavior model which predicts the likelihood the one or more controlled agents and/or the one or more uncontrolled agents will take one or more of the possible actions in a particular situation, and querying the adversarial planning engine and the cognitive behavior engine to develop a conditional mission plan which provides solutions to the user defined mission goals and problems.

In one embodiment, the method may further include the step of integrating the adversarial planning model and the cognitive behavior model by comparing one or more predicted possible actions of one or more uncontrolled agents in each of the one or more possible worlds generated by executing the adversarial planning model to predicted possible actions of the one or more uncontrolled agents in each of the one or more possible worlds generated by executing the cognitive behavior model to determine if the actions of the uncontrolled agents predicted by executing the adversarial planning model match the actions of the uncontrolled agents predicted by executing the cognitive behavior model. The method may include the step of executing the cognitive behavior model to predict the most likely one or more possible actions the one or more uncontrolled agents will perform. The method may include the step of executing the adversarial planning model to predict the most dangerous one or more possible actions the one or more uncontrolled agents will perform. The method may include the step of simulating one or more of the plurality of plans in and/or across one of the one or more possible worlds and simulating one or more plans of the conditional mission plan to provide an assessment of the conditional mission plan based on a predetermined number of simulations of the conditional mission plan. Each of the one or more possible worlds may include the modeled intention of the one or more controlled agents and/or the one or more uncontrolled agents.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a schematic block diagram showing the primary components of one embodiment of the cognitive interactive mission planning system of this invention;

FIG. 2 is a graph showing an example of a conditional mission represented in TAEMS;

FIG. 3 is a view of one example of the visualization of a possible world in accordance with this invention;

FIGS. 4A.1 and 4A.2 are flow charts showing primary steps of one exemplary operation of the cognitive interaction mission planning system of this invention; and

FIGS. 4B.1 and 4B.2 are continuations of the flow chart shown in FIG. 4A2.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

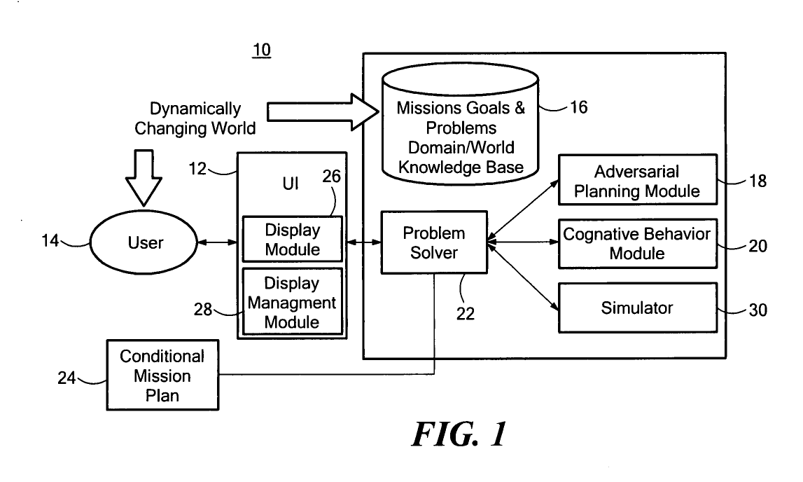

There is shown in FIG. 1 one embodiment of cognitive interactive mission planning system 10 of this invention. System 10 includes user interface (UI) engine 12 configured to support mixed initiative interaction and user defined mission goals and problems. Preferably, the mixed initiative interaction may include multi-modal input (e.g., speech, communicative actions, communicative gestures, and the like) a party to the mixed initiative interaction can take by requesting or informing another party to the mixed initiative interaction to perform one or more possible actions at any particular point in time. In one example, the mixed initiative interaction may include a user 14, e.g., a commander, providing instructions to system 10 via user interface engine 12 which may reside on a computer subsystem. The user defined mission goals and problems, typically input by user 14, include mission goals and objectives of the mission plan. Knowledge base 16 is configured to store and retrieve domain knowledge and rules associated with properties of each of the possible worlds of interest and the user defined mission goals and problems. Domain knowledge may include possible actions of one or more controlled agents and/or one or more uncontrolled agents (enemy agents).

Adversarial planning engine 18 executes an adversarial planning model to develop one or more plans for one or more controlled agents (hereinafter “controlled agents”) based on possible actions of one or more uncontrolled agents (hereinafter “uncontrolled agents”) to provide a plurality of plans which includes a best plan for the controlled agents in each of the one or more possible worlds (hereinafter “possible worlds”) based on a scoring function. Preferably, the scoring function inputs each of the plurality of plans provided by adversarial planning engine 18 and generates a score which corresponds how well each of the plurality of plans is achieved, discussed in further detail below. In one design, adversarial planning engine 18 may use an automated possible worlds analysis system, e.g., as disclosed in the Assignee's co-pending application Ser. No. 12/386,372 filed on Apr. 17, 2009, entitled “A Possible Worlds Analysis System and Method”, incorporated by reference herein. In one example, adversarial planning engine 18 uses TAEMS, a graph type modeling language known to those skilled in the art, to develop the adversarial planning model. Other modeling languages known to those skilled in the art may also be used. See e.g., “The TAEMS White Paper” by Horling et al., University of Massachusetts, Amherst, Mass., incorporated by reference herein. Ideally, adversarial planning engine 18 provides the best plan which predicts the most dangerous actions the uncontrolled agents will perform in a selected possible world.

Cognitive behavior engine 20, FIG. 1, executes a cognitive behavior model which predicts the likelihood the controlled agents and/or the uncontrolled agents will take possible actions in a particular situation. In one design, cognitive behavior engine 20 typically uses a cognitive programming architecture, e.g., ACT-R cognitive architecture, which incorporates theory about how human cognition works, See e.g., “An Integrated Theory of the Mind”, Anderson, J. R., et al., Physiological Review, Vol. III, No. 4, pp. 1036-1060 (2004), and “How Can the Human Mind Occur in the Physical Universe?”, Anderson, J. R., N.Y., N.Y., Oxford University Press, (2007), both incorporated by reference herein, as or similar type cognitive programming architecture known to those skilled in the art. Cognitive behavior engine 20 creates cognitive models that predict how the controlled agents and/or the uncontrolled agents will behave in a particular situation. One feature of cognitive behavior engine 20 is it can model the intentions the controlled agents and/or the uncontrolled agents are trying to achieve in each of the possible worlds. Cognitive behavior engine 20 can also utilize sensor information (e.g., intelligence information (Intel), visual cue data from the controlled agents, sensor data, reports, and the like) to determine what intentions were performed by the uncontrolled agents. Such senor information may also be used to update knowledge base 16 either via user interface engine 12 and user 14, or directly through a sensor message to knowledge base 16.

Problem solver 22 queries adversarial planning engine 18 and cognitive behavior engine 20 and develops conditional mission plan 24 which provides solutions to user defined mission goals and problems. Conditional mission plan 24 preferably includes the observed action data of the controlled agents and/or the uncontrolled agents for each of the possible worlds. Conditional mission plan 24 also preferably includes the most likely actions of the controlled agents and/or the uncontrolled agents, as well as the most dangerous actions of the uncontrolled agents. Conditional mission plan 24 developed by system 10 may be utilized for military type systems or various types of operational based systems, such as marketing systems, or other systems where the domain can be modelled as being completely or partially observable and the actions of the controlled agent need to be optimized with respect to the actions of other agents in the domain. In other words, anywhere where the behavior of an agent may influence or change the behavior of other agents and is in turn itself influenced by the behavior of other agents in order to achieve its desired goals. System 10 is preferably configured to perform the steps discussed herein which may be simulated on a general purpose computer.

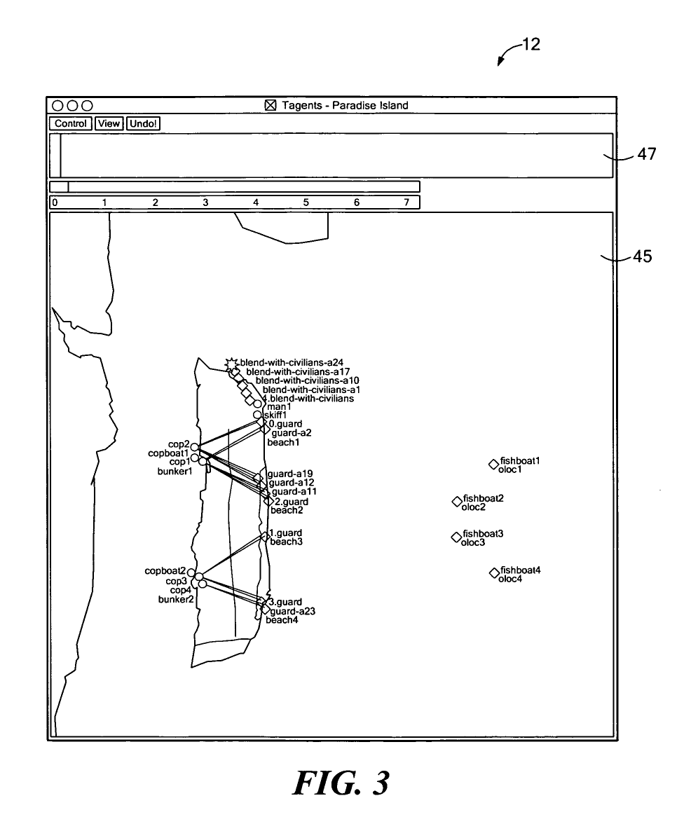

In one embodiment, user interface engine 12 includes display engine 26 which displays visualizations of the possible worlds associated with the plurality of plans generated by adversarial planning engine 18 which are relevant to the current state of the mixed initiative interaction. User interface engine 12 may also include display management engine 28 configured to control and maintain the state of the mixed initiative interaction. FIG. 3 shows one example of user interface 12 displaying visualization of possible world 45 on screen 47 of a computer subsystem (not shown).

In a preferred embodiment, problem solver 22, FIG. 1, integrates the adversarial planning model and the cognitive behavior model used by adversarial planning engine 18 and cognitive behavior engine 20, respectively, by comparing one or more predicted possible actions of the uncontrolled agents in each of the possible worlds generated by adversarial planning engine 18 to predict possible actions of the uncontrolled agents in each of the possible worlds generated by cognitive behavior engine 20 to determine if the actions of the uncontrolled agents predicted by adversarial planning engine 18 match the actions of the uncontrolled agents predicted by cognitive behavior engine 20. When the actions do not match, problem solver 22 initiates adversarial planning engine 18 to provide a new set of plans which includes a best plan for the controlled agents given the actions of the uncontrolled agents predicted by cognitive behavior engine 20.

For example, in operation, problem solver 22 queries adversarial planning engine 18 as to what actions each of the controlled agents and/or the uncontrolled agents may perform in a selected possible world from the possible worlds. Problem solver 22 then queries cognitive behavior engine 20 to determine what actions each of the controlled agents and/or the uncontrolled agents will perform based on the selected possible world at a particular moment in time. Cognitive behavior engine 20 then provides the most likely actions the modeled uncontrolled agents will perform in the selected possible worlds, e.g. “what will the enemy agents do”. If the predicted actions of the uncontrolled agents provided by cognitive behavior engine 20 in a selected possible world match the actions of the uncontrolled agents predicted by the adversarial planning engine 18, no further processing is required. However, if the actions of the uncontrolled agents predicted by cognitive behavior engine 20 do not match those predicted by adversarial planning engine 18, problem solver 22 requests adversarial planning engine 18 to develop a new plan in a newly selected possible world that includes the actions of the uncontrolled agents predicted by cognitive behavior engine 20. The result is system 10 provides conditional mission plan 24 which models the intentions of the uncontrolled agents in order to determine what they are trying to achieve.

Problem solver 22 may also use adversarial planning engine 18 and cognitive behavior engine 20 to resolves conflicts which may result when the controlled agents and the uncontrolled agents are performing an action that cannot happen simultaneously. That is, when the actions predicted for the different agents acting independently cannot obtain simultaneously, a “conflict” is flagged by adversarial planning engine 18. In this case, one or more agents would not succeed in executing their planned actions (and would also believe that they would not succeed given the actions of the other agent at that time and what the agent is able to observe). For example if a controlled agent unit is guarding the beach and an uncontrolled agent unit is landing drugs, either the drug landing must fail or the guard action must fail. This conflict would be known by the uncontrolled agent if it can see the controlled agent guarding the beach and vice-versa. If the controlled agent is not able to detect the uncontrolled agent, it would believe the guard action is successful and therefore no conflict would be flagged. Instead the plan would simply be considered to fail (for the controlled agents) in that possible world, indicating that some other set of actions to prevent the uncontrolled agents from reaching the beach with drugs should be considered. In one example, problem solver 22 may use a hybrid predetermined/deterministic planning system to, inter alia, generate hybrid contingency plans for each agent in each of one or more possible worlds and compare the hybrid contingency plans to determine conflicts, as disclosed in the Assignee's co-pending U.S. application Ser. No. 12/386,371, filed on Apr. 17, 2009, entitled “A Hybrid Probabilistic/Deterministic System and Method”, incorporated by reference herein.

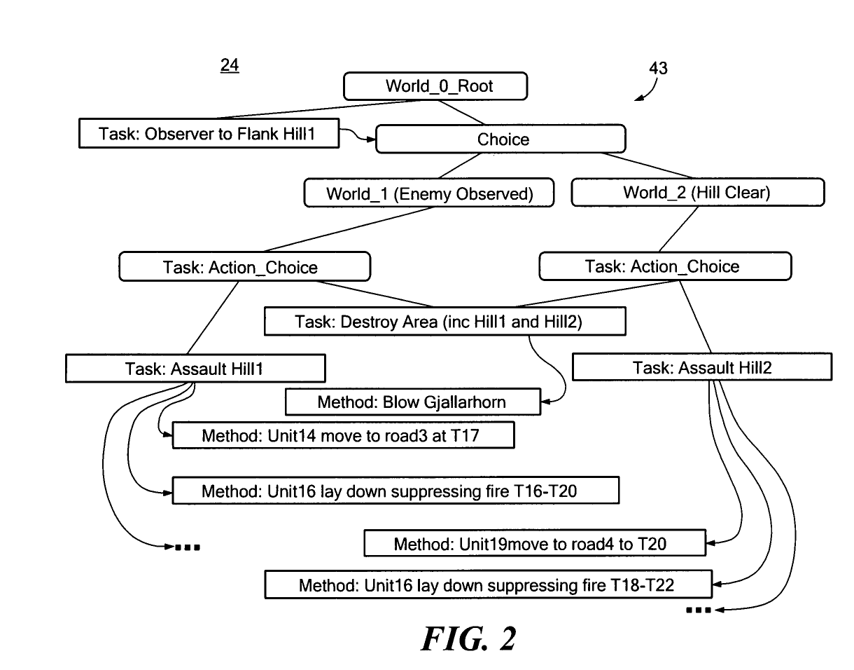

Problem solver 22, FIG. 1, uses a description of the controlled agents and a set of possible uncontrolled agents' goals and deployments to drive adversarial reasoning using adversarial planning engine 18 about best initial plan for the controlled agents and the uncontrolled agents. Problem solver 22 queries cognitive behavior engine 20 and suggests likely actions of the uncontrolled agent when conflicts are presented. User 14, with user interface engine 12, may select between the various possible future of possible worlds based on the prediction of the behavior of the uncontrolled agents provided by problem solver 22, or override problem solver 22 with user 14's own selection. When significant action choices are possible, user 14 may select alternative action choices for the uncontrolled agents and/or the controlled agents to see how the future is affected. Each action may have a probabilistic outcome and user 14 may decide to only examine the most likely outcome (for which the course of action (COA) is automatically generated) or force problem solver 22 to consider a less likely outcome. This populates a “tree” of possible worlds with these different futures and a particular COA is any path from a tree root (one of the possible starting conditions of a possible world for the uncontrolled agents) to an end state (where the uncontrolled agents or the controlled agents have achieved their goals, or an unresolved conflict remains). This tree is represented using a plan representation, e.g., TAEMS, and may be considered the conditional mission plan 24 output by the planning process of system 10. FIG. 2 shows one example of tree 43 representing a simplified conditional mission plan 24 used for illustrative purposes only. A typical conditional mission plan 24 is much more complex and may include hundreds of pages. The analysis is done over multiple possible worlds and system 10, FIG. 1, generates a number of COAs. The execution preference at a particular choice point is then toward those possible worlds in which the controlled agents have achieved their goals while avoiding those in which the uncontrolled agents achieves their goals. This leads to a set of conditional COAs that are preferred by the controlled agents, implemented, and included in conditional mission plan 24. One primary goal achieved by system 10 is to help user 14, e.g., a commander, create a force lay-down of resources. Another goal achieved by system 10 is to assist the commander in understanding operationally what is really happening, discover differences from the plan assumptions, and, critically use a model learned of the commander while the commander was exploring, and continues to explore, the plans, as well as the preferences of the commander. This “intention recognition” is then used to inform future responses by system 10, implying that even as the reality of the situation drifts from the plan, system 10 can create informed operational responses automatically, either issued by the commander (e.g., suggested plan changes), or implemented directly when time is of the essence and the confidence in the intentional model of the commander is sufficient.

The result is that cognitive interactive mission planning system 10 of this invention effectively combines adversarial planning and cognitive behavior planning with a problem solver and an interactive user interface engine to generate one or more conditional mission plans which provide solutions to user defined mission goals and problems. System 10 includes the ability to include possible worlds with the intentions of the uncontrolled agents and/or the controlled agents in each of the possible worlds. The conditional mission plan which may include the most likely actions of the uncontrolled agents and/or the controlled agents will take, as well as the most dangerous actions of the uncontrolled agents. Cognitive interactive mission planning system 10 also allows a user, e.g., a commander, to interact with the system and provides the ability for the user to evaluate the conditional mission plan, using simulator 30 (discussed below). System 10 can also handle exogenous events.

One or more possible actions of the uncontrolled agents and/or the controlled agents may include constraints associated with the possible actions of the uncontrolled agents and/or the controlled agents. The possible actions may include user provided predictions associated with the possible actions of the uncontrolled agents. Adversarial planning engine 18 also can be used to suggest resolutions to conflicts of the best plan. Similarly, cognitive behavior engine 20 may also suggest resolutions to possible conflicts, e.g. alternative actions that do not produce a conflict may be suggested.

In one design, cognitive interactive mission planning system 10 includes simulation engine 30 which simulates conditional mission plan 24 to provide an assessment of conditional mission plan 24 based on a predetermined number of simulations. The uncontrolled agents are typically simulated using behavior models that may or may not be the same as the behavior models used by cognitive behavior engine 20 when validating the predictions of cognitive behavior engine 20 against the predictions of other behavior models. The controlled agents are typically simulated using behavior models that are incorporated into the simulator 30, e.g., strictly follow the plan, follow the plan with some variation, use a behavior model that simulates controlled agent moral, fatigue, and the like. In one example, simulator 30 may also simulate one or more of the plurality of plans generated by adversarial planning engine 18 in and/or across one or more of the possible worlds.

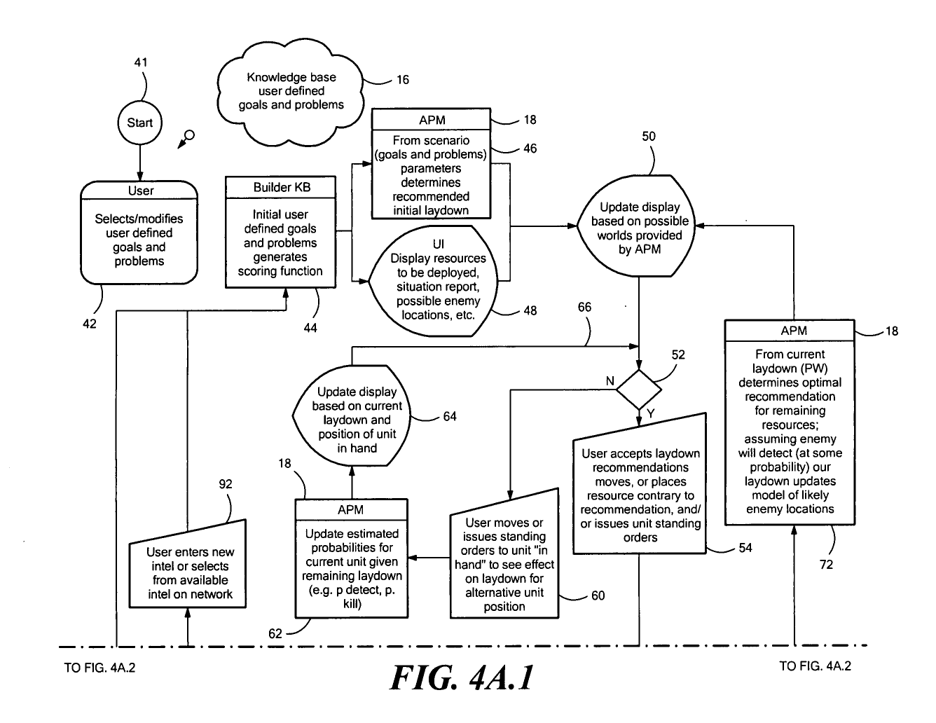

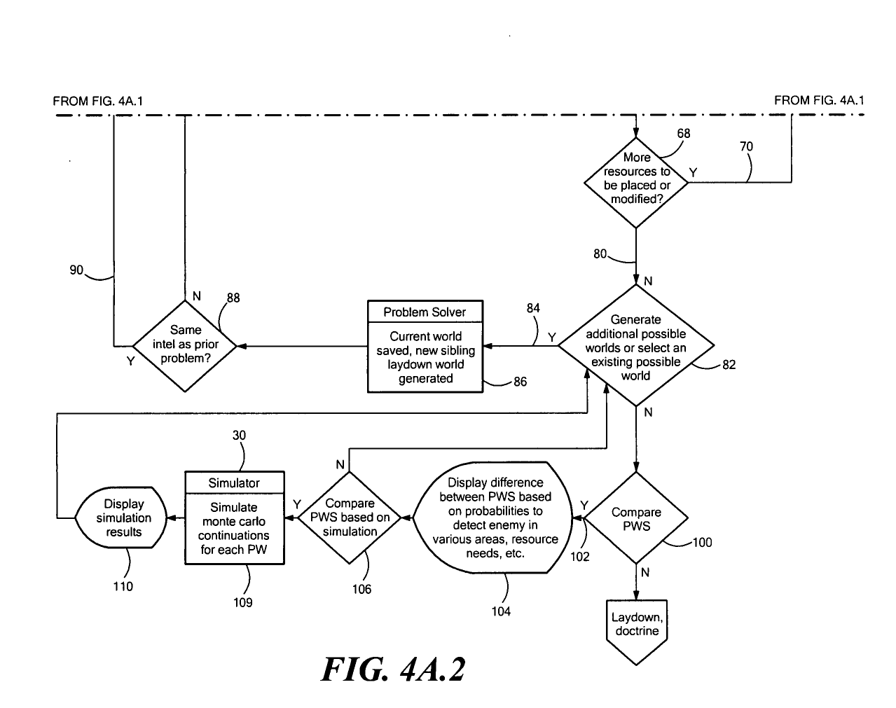

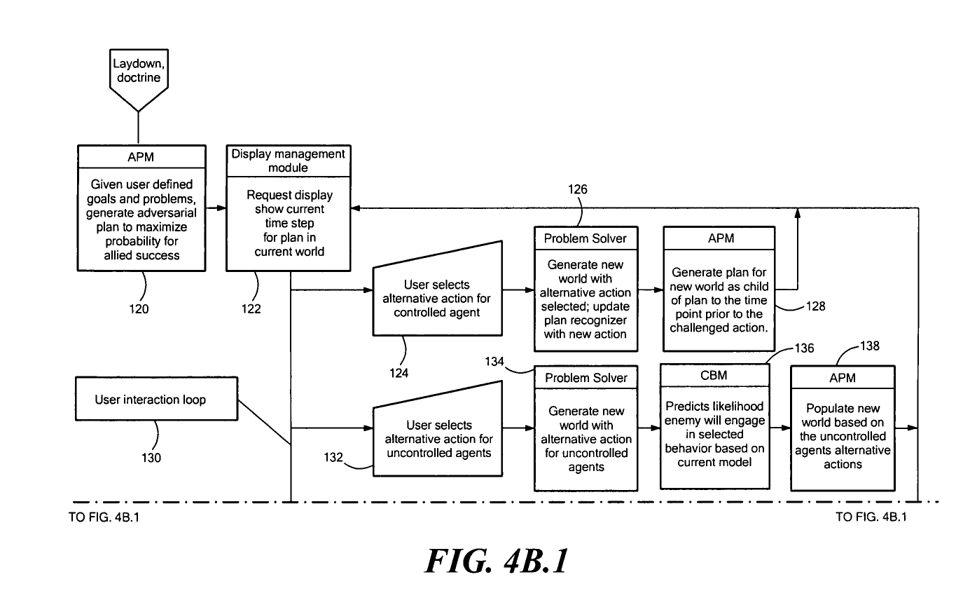

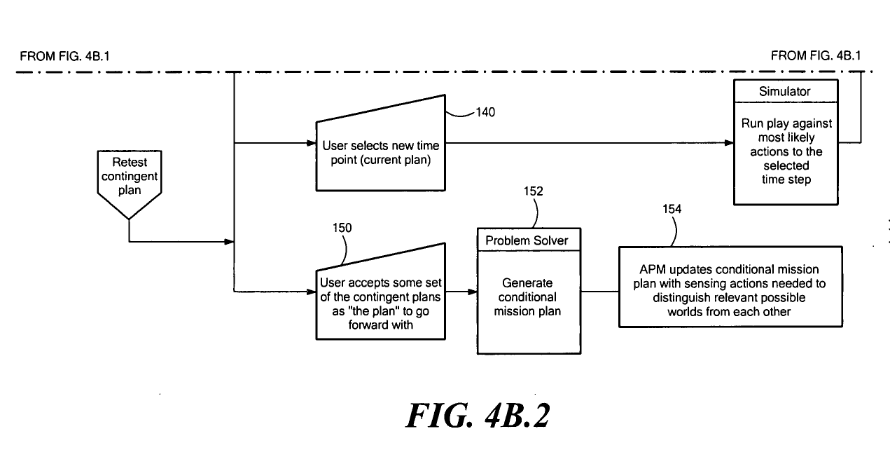

One exemplary operation of cognitive interaction mission system 10 of this invention is discussed below with reference to FIGS. 1, 4A.1-4B.2. In this example, user 14, FIG. 1, initiates system 10, indicated at 41, FIG. 4A.1. User 14 then selects or modifies user defined mission goals in knowledge base 16, step 42. This builds and/or updates knowledge base 16 with the initial user defined goals and problems and builds a scoring function, step 44. Adversarial planning engine 18 then uses the goals and problems (scenario parameters) in knowledge base 16 to determine an initial lay-down, e.g. a possible world, of the controlled agents and related resources, step 46. For example, the initial laydown of a possible world may include the units available to user 14, e.g., a commander, which are displayed either in positions required by the scenario on a map (e.g., fixed units) or in a list for mobile units which can be iterated through to be placed individually, based on input representing the notions of user 14 or suggestions from system 10. System 10 may simulate a private “game” scenario to calculate an optimum laydown based on expected uncontrolled agents (enemy) activities, e.g., in the example shown in FIG. 2, a sensor (if available) should be placed where it can detect a tank on Hill 1 or Hill 2, that a unit be placed where it can flank and observe Hill 1, the same unit or another be placed where it can flank and observe Hill 2, and the like. Display engine 26 displays the resources to be deployed, a situation report, and possible uncontrolled agents (enemy) locations, and the like, step 48. System 10 then updates and displays the possible worlds provided by adversarial planning engine 18, step 50. The user then selects a unit from the list of units to be placed or have already been placed in the scenario causing the unit to be “in hand.” A “no” decision by user 14 using interface 12 at decision block 52 indicates user 14 moves or issues standing orders to the unit “in hand” (the controlled agents) to see the effect of the lay-down for alternate unit position, step 60. Adversarial planning engine 18 then updates the estimated probabilities for current unit given remaining lay-down, e.g., detect, kill, and the like, step 62. Display engine 26 then updates the display based on the current lay-down (possible world) and the position of the unit in hand, step 64. This leads back to decision block 52, indicated by line 66. A “yes” decision at decision block 52 indicates user 14 has accepted lay-down recommendation for the unit “in hand” by adversarial planning engine 18, user 14 moves or places resources contrary to the recommendations provided by adversarial planning engine 18, and/or user 14 issues unit standing orders, step 54. At decision block 68, FIG. 4A.2, a determination is made as to whether more resources have yet to be placed or may be modified from their existing placement. If “yes”, indicated at 70, adversarial planning engine 18 uses the current state of the lay-down (possible world) to determine the optimal recommendations for remaining resources, assuming the enemy will detect (at some probability) the lay-down of the controlled agents and resources given the adversarial planning model of the most likely enemy locations, step 72. The results are then displayed using display engine 26, step 50. At decision block 68, if all resources have been placed and none need to be modified, indicated at 80, system 10 optionally generates additional possible worlds (PWs) for comparison, or allows an existing PW to be selected for comparison, step 82. This typically involves contrary intelligence on initial enemy starting locations or intentions. If more possible worlds are desired, indicated at 84, problem solver 12 saves the current possible world and generates a new sibling possible world, step 86. This leads to decision block 88 where a determination is made whether the intelligence is the same as the prior problem. If “yes”, indicated at 90, system 10 returns to step 44. If “no”, user 14 enters new intelligence information or selects from available intelligence on a network, step 92, which leads back to step 44. At decision block 100 a comparison of the lay-downs, or possible worlds, is suggested when there is more than one possible world. If a comparison of the possible worlds is needed, indicated at 102, display engine 26 displays differences between the possible worlds based on probabilities to detect enemy agents in various areas, resources needs, and the like, step 104. A decision to compare possible worlds based on simulation is then made at decision block 106. If “yes”, simulator 30 then simulates Monte-Carlo continuations for each possible world being compared, step 109. Display engine 26 then displays the simulation results, step 110. This leads back to decision block 82. A “no” at block 106 bypasses the Monte-Carlo simulation and leads back to decision block 82. If no comparison of possible worlds is needed at decision block 100, then adversarial planning engine 18 employs user defined goals in knowledge base 16 to generate an adversarial plan that maximizes the probability of success, step 120, FIG. 4B.1. Display management engine 28 then responds to a request from user 14 to display and show the current time step for a plan in the current world which reads and compares possible worlds by simulation, step 122. User 14 may then selects an alternative action for the controlled agents, step 124. This initiates problem solver 22 to generate a new possible world with the alternative action and update the adversarial plan of adversarial planning engine 18 with a new action, step 126. Adversarial planning engine 18 then generates a new plan for the new possible world as a child of the plan to the time of point of the changed action, step 128. This leads back to step 122, where display management engine 28 interacts with user 14 via user interaction loop 130. User 14 may select an alternative action for the uncontrolled agents, step 132. Similarly, problem solver 22 will generate a new possible world with the alternative action selected by user 14 for the uncontrolled agents and model the new action, step 134. Cognitive behavior engine 20 then predicts the likelihood the enemy, or uncontrolled agents, will engage in selected behavior based on the current model, step 136. Adversarial planning engine 18 then populates the new possible world based on the alternate actions of the uncontrolled agents, step 138. User interaction loop 130 may also allow the user 14 to select a new time, step 140, FIG. 4B.2. This causes simulator 30 to run the new plan against most likely actions of the uncontrolled agents and/or the controlled agents to the selected time step This leads back to step 122, where display management engine 28 updates the display for the output of the simulation and then interacts with user 14 via user interaction loop 130. At some point, user 14 accepts some set of contingent plans as “the plan”, or conditional mission plan 24 to go forward with, step 150. Problem solver 12 then generates conditional mission plan 24, step 152. Adversarial planning engine 18 then updates conditional mission plan 24 with sensing actions needed to distinguish the relevant possible worlds from each other, step 154.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

Other embodiments will occur to those skilled in the art and are within the following claims.

What is claimed is:

1. A cognitive interactive mission planning system apparatus comprising:
a user interface engine configured to support mixed initiative interaction and user defined mission goals and problems;
a knowledge base configured to store and retrieve domain knowledge and rules associated with properties of each of one or more possible worlds of interest and the user defined mission goals and problems;
an adversarial planning engine configured to execute an adversarial planning model in order to develop one or more plans for one or more controlled agents based on possible actions of one or more uncontrolled agents to provide a plurality of plans which includes a best plan for the one or more controlled agents in each of the one or more possible worlds based on a scoring function;
a cognitive behavior engine configured to execute a cognitive behavior model which predicts the likelihood the one or more controlled agents and/or the one or more uncontrolled agents will take one or more of the possible actions in a particular situation; and
a problem solver engine configured to query the adversarial planning engine and the cognitive behavior engine to develop a conditional mission plan which provides solutions to the user defined mission goals and problems.

2. The system of claim 1 in which the user interface engine includes a display engine configured to display visualizations of the one or more possible worlds associated with one or more of the plurality of plans relevant to the current state of the mixed initiative interaction.

3. The system of claim 1 in which the user interface engine includes a display management engine configured to control and maintain the state of the mixed initiative interaction.

4. The system of claim 1 in which the scoring function inputs each of the plurality of plans provided by the adversarial planning engine and generates a score which corresponds to how well each of the plurality of plans is achieved.

5. The system of claim 1 in which the adversarial planning engine is configured to suggest resolutions to possible conflicts of the best plan.

6. The system of claim 1 in which the cognitive behavior engine is configured to suggest resolutions to possible conflicts of the best plan.

7. The system of claim 1 in which the cognitive behavior engine is configured to predict the likelihood a modeled one or more uncontrolled agents will perform each of the one or more possible actions in each of the one or more possible worlds.

8. The system of claim 10 in which the problem solver engine integrates the adversarial planning model and the cognitive behavior model by comparing one or more predicted possible actions of one or more uncontrolled agents in each of the one or more possible worlds generated by the adversarial planning engine to predicted possible actions of the one or more uncontrolled agents in each of the one or more possible worlds generated by the cognitive behavior engine to determine if the actions of the uncontrolled agents predicted by the adversarial planning engine match the actions of the uncontrolled agents predicted by the cognitive behavior engine.

9. The system of claim 8 in which the problem solver engine initiates the adversarial planning engine to provide a new plurality of plans which includes a best plan for the one or more controlled agents when the actions of the uncontrolled agents predicted by the adversarial planning engine do not match the actions of the uncontrolled agents predicted by the cognitive behavior engine.

10. The system of claim 8 in the cognitive behavior engine is configured to predict the most likely one or more possible actions the one or more uncontrolled agents will perform.

11. The system of claim 8 in the adversarial planning engine is configured to predict the most dangerous one or more possible actions the one or more uncontrolled agents will perform.

12. The system of claim 1 further including a simulation engine configured to simulate a one or more the plurality of plans in and/or across one of the one or more possible worlds and configured to simulate one or more plans of the conditional mission plan to provide an assessment of the conditional mission plan based on a predetermined number of simulations of the conditional mission plan.

13. The system of claim 1 in which each of the one or more possible worlds includes the modeled intention of the one or more controlled agents and/or the one or more uncontrolled agents.

14. A cognitive interactive mission planning system apparatus comprising:
an adversarial planning engine configured to execute an adversarial planning model in order to develop one or more plans for one or more controlled agents based on possible actions of one or more uncontrolled agents to provide a plurality of plans which includes a best plan for the one or more controlled agents in each of the one or more possible worlds based on a scoring function;
a cognitive behavior engine configured to execute a cognitive behavior model which predicts the likelihood the one or more controlled agents and/or the one or more uncontrolled agents will take one or more of the possible actions in a particular situation; and
a problem solver engine configured to query the adversarial planning engine and the cognitive behavior engine to develop a conditional mission plan which provides solutions to the user defined mission goals and problems.

15. A cognitive interactive mission planning method comprising:
receiving input in the form of mixed initiative interaction and user defined mission goals and problems;
storing and retrieving domain knowledge and rules associated with properties of each of one or more possible worlds of interest and the user defined mission goals and problems;
executing an adversarial planning model in order to develop one or more plans for one or more controlled agents based on possible actions of one or more uncontrolled agents to provide a plurality of plans which includes a best plan for the one or more controlled agents in each of the one or more possible worlds based on a scoring function;
executing a cognitive behavior model which predicts the likelihood the one or more controlled agents and/or the one or more uncontrolled agents will take one or more of the possible actions in a particular situation; and
querying the adversarial planning engine and the cognitive behavior engine to develop a conditional mission plan which provides solutions to the user defined mission goals and problems.

16. The method of claim 15 further including the step of integrating the adversarial planning model and the cognitive behavior model by comparing one or more predicted possible actions of one or more uncontrolled agents in each of the one or more possible worlds generated by executing the adversarial planning model to predicted possible actions of the one or more uncontrolled agents in each of the one or more possible worlds generated by executing the cognitive behavior model to determine if the actions of the uncontrolled agents predicted by executing the adversarial planning model match the actions of the uncontrolled agents predicted by executing the cognitive behavior model.

17. The method of claim 16 further including the step of executing the cognitive behavior model to predict the most likely one or more possible actions the one or more uncontrolled agents will perform.

18. The method of claim 16 further including the step of executing the adversarial planning model to predict the most dangerous one or more possible actions the one or more uncontrolled agents will perform.

19. The method of claim 16 further including the step of simulating one or more of the plurality of plans in and/or across one of the one or more possible worlds and simulating one or more plans of the conditional mission plan to provide an assessment of the conditional mission plan based on a predetermined number of simulations of the conditional mission plan.

20. The system of claim 15 in which each of the one or more possible worlds includes the modeled intention of the one or more controlled agents and/or the one or more uncontrolled agents.
